(19) United States
(12) Patent Application Publication
(10) Pub. No.: US 2026/0227235 A1
(43) Pub. Date: Aug. 6, 2026

(54) METHOD AND SYSTEM FOR ALIGNMENT AND/OR STABILIZATION OF AN ENTANGLED PHOTON SOURCE

(71) Applicants: Quantum Industries GmbH, Vienna (AT); Quantum Technology Laboratories GmbH, Vienna (AT)

(72) Inventors: Lukas BULLA, Vienna (AT); Sebastian ECKER, Vienna (AT); Matthias FINK, Vienna (AT); Armin HOCHRAINER, Vienna (AT); Sebastian Philipp NEUMANN, Vienna (AT)

(21) Appl. No.: 19/149,710

(22) PCT Filed: Jan. 26, 2024
(86) PCT No.: PCT/EP2024/051839

§ 371 Date: Jul. 21, 2025

(30) Foreign Application Priority Data
Jan. 26, 2023 (EP) 23153460.3

(51) Int. Cl. G01J 1/42; G01J 1/04; G02F 1/35

(52) U.S. Cl. CPC G01J 1/4257; G01J 1/0437; G02F 1/3503

(57) ABSTRACT

It is claimed a method for alignment and/or stabilization of an entangled photon source (2) with the steps, i) generation of a polarized pump beam (10) by a pump laser (1); ii) generation of entangled photons (20) by guidance of the pump beam (10) to a non-linear element (21) in the source (2) via one or more alignment means. According to the invention the method comprises the steps iii) measurement of the pump beam (10) after the generation of the entangled photons (20) by spatial mode filtering of the pump beam (10) and detection of the spatial mode filtered pump beam (11) after the generation of the entangled photons (20); iv) generation of a control signal (12) based on the spatial mode filtered pump beam (11) in a control means (5); v) adjustment of the one or more alignment means by the control signal (12) in order to align and/or stabilize the spatial mode of the pump beam (10) in the source (2).

The present invention provides a method for alignment and/or stabilization of an entangled photon source according to the preamble of claim 1 and a system for alignment and/or stabilization of an entangled photon source according to the preamble of claim 13.

As of today, the most efficient method of preparing entangled photons is via spontaneous parametric down-conversion (SPDC) which occurs in highly birefringent non-linear crystals arranged in a source. In order to generate entangled photons via spontaneous parametric down-conversion (SPDC), the non-linear crystal is pumped by a pump laser. The alignment of the pump laser beam is crucial in free-space sources, since it inherits its spatial mode to the entangled photons. For that a precise alignment of the optical components for guiding the pump beam to and through the non-linear crystal is important. In addition, after initial alignment, drifts of the optical components can deteriorate over time which in known systems is countered by periodic manual alignment of the optical components.

It is an object of the present invention to provide an improved alignment and stabilization method and system for a large variety of entangled photon sources.

According to the present invention, a method for alignment and stabilization of an entangled photon source is provided according to claim 1.

This object is achieved by a method for alignment and/or stabilization of an entangled photon source with the steps,
i) generation of a polarized pump beam by a pump laser;
ii) generation of entangled photons by guidance of the pump beam to the nonlinear element in the source via one or more alignment means.

According to the invention the method comprises the steps
iii) measurement of the pump beam after the generation of the entangled photons by spatial mode filtering of the pump beam by a spatial mode filter means and detection of the spatial mode filtered pump beam by a detection means after the generation of the entangled photons;
iv) generation of a control signal based on the spatial mode filtered pump beam in a control means;
v) adjustment of the one or more alignment means by the control signal in order to align and/or stabilize the spatial mode of the pump beam in the source.

According to the present invention, a system for alignment and/or stabilization of an entangled photon source is provided according to claim 13.

The object is further achieved by a system for alignment and/or stabilization of an entangled photon source, comprising a pump laser generating a pump beam, a source and one or more alignment means,
whereby the source is arranged behind the pump laser and comprises a nonlinear element for the generation of entangled photons, and
whereby the alignment means are arranged inside and/or outside of the source in order to guide the pump beam to the non-linear element after the generation of the entangled photons.

According to the invention, the system comprises a spatial mode filter means arranged behind an output port of the source of the pump beam, and
the system comprises a detection means, arranged behind the spatial mode filter means, and
the system comprises a control means for controlling the spatial mode of the pump beam, whereby a control loop is formed by the pump laser, the one or more alignment means as actuation means, the spatial mode filter means, the detection means and the control means.

An advantage of the inventive method and inventive system is the automated alignment and/or stabilization of the spatial mode of the pump beam in the entangled photon source leading to a stable generation of entangled photons with constant quality properties. This is realized by monitoring the pump beam after the generation of entangled photons. After the generation of the entangled photons means here, that the pump beam is first used to pump the non-linear element for the generation of the entangled photons and after that the pump beam is spatially mode filtered. The spatial mode filtering can be realized behind the source, whereby the pump beam is in that embodiment transmitted through the source. The spatial mode filtering can also be realized between the source and the pump laser, whereby in that embodiment the pump beam is reflected in the source or guided through the source back towards the pump laser. Thus, by the inventive method and the inventive system it is not necessary to measure the generated entangled photons to check and stabilize the alignment of the source and the properties of the entangled photons, but by monitoring the pump beam after the entangled photon generation. This eliminates the need to interrupt the entangled photon generation and key generation by quantum key distribution (QKD) for maintenance and adjustment purposes.

Alignment of the source or the spatial mode of the pump beam means here that the pump beam is adjusted in order to be guided towards and through the nonlinear element in order to generate entangled photons and stabilization means that the spatial mode of the pump beam towards and through the non-linear element is kept stable during the generation of the entangled photons. The spatial mode of the pump laser beam through the non-linear element is crucial, since the pump beam inherits its spatial mode to the entangled photons. The alignment of the source is realized during the generation of entangled photons, before using the entangled photons for example for quantum communication or quantum key distribution. The advantage is the high quality of the entangled photons by the aligned photon source for quantum communication or quantum key distribution. Stabilization of the source means that the alignment is performed continuously or in one or more time-intervals during the generation of the entangled photons while using the entangled photons for example for quantum communication or quantum key distribution.

In a preferred embodiment, the control signal is an electrical signal, preferably whose magnitude is proportional to the spatial mode filtered and detected pump beam, preferably proportional to the intensity and/or the polarization of the spatial mode filtered and detected pump beam. The advantage of a control signal proportional to the intensity is the precise and cost-efficient alignment and/or stabilization of the source.

In a preferred embodiment, in the measurement in step iii) the intensity and/or the polarization of the spatial mode filtered pump beam is detected by a detection means. The detection is realized by the detection means after the spatial mode filtering of the pump beam by a spatial mode filter means. The advantage of the measurement of the intensity is the cost-effective detection. The advantage of the detection of the polarization is the measurement of an additional degree of freedom of the pump beam.

In a preferred embodiment, the detection means is an intensity detection element, preferably a photodiode or a thermal power sensor or an energy sensor or a power-meter sensor. By this detection means the intensity of the pump beam can be detected in a precise manner. The advantage of a photodiode is the fast response time and the high resolution. The advantage of the thermal power sensor is a broad spectral range. The advantage of the energy sensor is the use for pulsed applications over a broad spectral range. Preferably, the detection means comprises in addition a polarization means arranged in front of the intensity detection element, preferably a polarizing beam splitter or a polarizer, preferably a rotatable polarizer. By that arrangement the polarization of the pump beam can be detected.

In a preferred embodiment, the steps i) to v) form a control during the generation of the entangled photons by pumping the non-linear element by the pump beam. Control means here the alignment and/or the stabilization of the entangled photon source. Essential here is, that the alignment and/or stabilization is realized while the entangled photons are generated by pumping the non-linear element.

In a preferred embodiment, the control comprises
a) the generation of a pump beam in step i),
b) the measurement of the pump beam in step iii) after the generation of the entangled photon pairs in step ii),
c) the generation of a control signal based on the spatial mode filtered and detected pump beam in step iv), and
d) the adjustment of the one or more alignment means by the control signal in step v).

In a preferred embodiment, the control means in step iv) compares the actual value of the spatial mode filtered pump beam with a setpoint value and the control means determines and generates the control signal on the basis of the comparison. For the value of the spatial mode filter pump beam the signal of the intensity signal detection means can be used.

In a preferred embodiment, the setpoint value is set manually or is set by properties defined by a first adjustment of the entangled photon source. By that, the properties like absorption or beam shaping of the used components in the source can be taken into account.

In a preferred embodiment, the control loop is permanently active. Permanently active means, that the entangled photons can be generated in the source while the alignment and/or stabilization takes place and while the entangled photons can be used for example for quantum communication or quantum key distribution. The advantage of the invention is that the control loop can be permanently active while generating entangled photons. An interruption of the generation of the entangled photons for adjustment or maintenance is not necessary.

In a preferred embodiment, the control loop can be deactivated at least temporarily or periodically. In order to check the spatial mode of the pump beam, the control loop can be switched on again periodically for a certain time.

In a preferred embodiment, the spatial mode filtering in step iii) is realized by coupling the pump beam into a single mode fiber, and/or by one or more apertures. In a preferred embodiment, the spatial mode filter means is a single mode fiber, and/or one or more apertures. The advantage of this embodiment is the simple and stable filter method. In addition, by the single mode fiber or the aperture the focus point and a displacement of the pump beam can be detected in a precise manner. By the use of a single mode fiber and one or more apertures a more sensitive alignment and/or stabilization can be realized. For that the one or more apertures are arranged in front of the single mode fiber.

In a preferred embodiment, the spatial mode filtering in step iii) is realized by a beam profile detection. The advantage of this embodiment is the detection not only of the beam diameter and thus the focus point, the displacement of the pump beam, but also a distortion of the beam profile which can be compensated for example by a deformable mirror.

In a preferred embodiment for single mode fiber and aperture as spatial mode filter means, the detected signal is proportional to the intensity of the spatial mode overlap.

The output port of the source for the pump beam is the spatial mode beam path on which the pump beam is leaving the source. This means, that the pump beam is guided through the source for the generation of entangled photons and then leaves the source via the output port.

In a preferred embodiment, the pump beam is spatially mode filtered in the spatial mode filter means after a transmission of the pump beam through the source. In a preferred embodiment, the output port of the source for the pump beam differs to an input port of the source for the pump beam. This means the pump beam enters and leaves the source on different spatial mode beam paths. In this embodiment, the spatial mode filter means is arranged behind the output port of the source. The advantage of this embodiment is, that the spatial mode filter means and the detection means can be arranged outside of the source.

In a preferred embodiment, the pump beam is spatially mode filtered in the spatial mode filter means after a reflection of the pump beam in the source or a guidance back of the pump beam in the source towards the pump laser. In a preferred embodiment, the output port of the source for the pump beam is equal to an input port of the source for the pump beam. This means the pump beam enters and leaves the source on the same spatial mode beam path or the substantially same beam path. In this embodiment, the spatial mode filter means is arranged between the pump laser and the source, or branching off from the beam path of the pump beam between the pump laser and the source. The advantage is that the spatial filter means can be used for the pump beam before the generation of the entangled photon pairs, too. The branching off from the beam path of the pump beam between the pump laser and the source can be realized by a beam splitter or an isolator.

In a preferred embodiment, for the arrangement of the spatial mode filter means between the pump laser and the source the pump beam is guided in the source back to the pump laser, preferably on the same spatial mode out of the source. This can be realized by a reflection or guidance of the pump beam in the source or a loop configuration for the pump beam in the source, preferably a Sagnac-loop configuration.

The actuation means is the part of the control loop which possesses the physical variable to be controlled and on which the control means act, preferably in step v), via the control signal. The actuation means of the inventive method and system are the one or more alignment means arranged inside and/or outside of the source, whereby the alignment means arranged outside of the source are arranged between the source and the pump laser. The physical variable may be for example the position of one or more mirrors, and/or position of one or more lenses.

In a preferred embodiment, the control signal of the spatial mode filtered pump beam is used for the alignment and/or stabilization of the spatial mode of the pump beam.

In a preferred embodiment, the alignment and/or stabilization of the spatial mode of the pump beam is realized by the control of one or more alignment means. In a preferred embodiment, the alignment means is a movable mirror, and/or a deformable mirror, and/or an aperture, and/or a lens, and/or a collimator, and/or a beam displacer. In a preferred embodiment, the position and/or tip-tilt alignment of one or more mirrors, and/or the position and/or tip-tilt alignment and/or deformation of one or more deformable mirrors, and/or the position of one or more apertures, and/or the position of one or more lenses, and/or one or more waveplates, and/or one or more birefringent elements is controlled in order to align and/or stabilize the spatial mode of the pump beam. In a preferred embodiment, the alignment means align and/or stabilize the spatial mode of the pump beam. To align and/or stabilize the pump beam, one alignment means and one alignment manner, for example the tip-tilt alignment, can be realized but also two or more alignment means and two or more alignment manners can be combined to align and/or stabilize the pump beam. For example, by using two movable mirrors an offset of the pump beam can be corrected. In addition, by a deformable mirror, an aperture, a lens, a collimator and/or a beam displacer the focus point and the spatial mode of the pump beam can be corrected while the direction of the pump beam is aligned and/or stabilized by one or more mirrors. Thus, a combination of two or more alignment means and alignment manners lead to a more precise entangled photon source. By the use of two or more alignment means and two or more alignment manners each alignment means is controlled one after each other and each alignment manner is realized one after each other.

In a preferred embodiment, the physical variable to be controlled and on which the control means act for the mirror as alignment means is the position of the mirror and/or the angle of reflection of the mirror.

In a preferred embodiment, the physical variable to be controlled and on which the control means act for the alignment means as deformable mirror is the position of the deformable mirror and/or the angle of reflection of the deformable mirror, and/or the deformation of the surface of the deformable mirror.

In a preferred embodiment, the physical variable to be controlled and on which the control means act for the alignment means as aperture is the position of the aperture, and/or the diameter of the aperture, and/or the form of the aperture.

In a preferred embodiment, the physical variable to be controlled and on which the control means act for the alignment means as lens is the position of the lens, and/or the angle of transmission of the pump beam through the lens, and/or the focal length.

In a preferred embodiment, the physical variable to be controlled and on which the control means act for the alignment means as collimator is the position of the collimator, and/or the angle of transmission of the pump beam through the collimator, and/or the focal length of the collimator.

In a preferred embodiment, the physical variable to be controlled and on which the control means act for the alignment means as beam displacer is the position of the beam displacer.

All the aforementioned physical variable to be controlled and on which the control means act can be combined in order to obtain an even more precise alignment and/or stabilization of the source. Preferably, the different physical variables are controlled one after the other. By that the influence of the physical variable on the detected signal can be determined.

In a preferred embodiment, the control means is formed as a digital controller or as an analog circuit.

In a preferred embodiment, the alignment means are one or two or more mirrors, and/or beam displacer, and/or deformable mirrors arranged in front of the source in order to adjust and/or stabilize the spatial mode of the pump beam on an input port of the source. The input port of the source for the pump beam is the spatial mode beam path on which the pump beam enters the source. In a preferred embodiment, the input port depends on the position of the spatial mode of the pump beam and on the angle of arrival of the spatial mode of the pump beam. In a preferred embodiment, the input port is a spatial mode in a dichroic means, and/or a beam splitter, and/or a polarizing beam splitter in the source. The dichroic means, and/or a beam splitter, and/or a polarizing beam splitter in the source can be used for example to separate the generated entangled photons after the generation from the pump beam. By that the beam path and for example the offset of the pump beam on the input port of the source can be aligned and/or stabilized. To correct the offset, at least two components are necessary.

In a preferred embodiment, the alignment means are one or two or more mirrors, and/or deformable mirrors, and/or beam displacers arranged in the source in order to adjust and/or stabilize the spatial mode of the pump beam for guidance in the source. This embodiment can be used for adjustment and/or stabilization of the guidance of the spatial mode of the pump beam in the source towards the nonlinear element. The one or two or more mirrors arranged in the source can for example be a reflecting mirror in a source with one non-linear element pumped in two directions or the two or more mirrors forming a Sagnac-type loop, and/or for guidance of the pump beam to the non-linear element in a crossed crystal type source or a BBO source. For the generation of entangled photons, the position and/or angle of transmission of the pump beam in the non-linear element is crucial.

In a preferred embodiment, the alignment means are one or two or more lenses and/or deformable mirrors arranged outside and/or inside the source in order to adjust and/or stabilize the focus, and/or the width, and/or the form of the pump beam, preferably the focus, and/or the width, and/or the form of the pump beam in the non-linear element. For the generation of entangled photons, the properties of the pump beam in the non-linear element are crucial.

In a preferred embodiment, the pump laser is a continuous wave laser generating a continuous wave pump laser beam or a pulsed laser generating a pulsed pump laser beam.

In a preferred embodiment, the source is formed as a continuous wave entangled photon source or a pulsed entangled photon source.

In a preferred embodiment, the source is a Sagnac-type entangled photon source, or an entangled photon source with crossed crystals inside a Sagnac loop, or an entangled photon source using a crystal double-pass inside a Sagnac interferometer, or a crossed crystal type entangled photon source, or an entangled photon source with one non-linear element pumped in two directions, or a BBO-type entangled photon source, or a BiBO-type entangled photon source, or a beam-displacer entangled photon source, or a parallel-crystal entangled photon source, or a folded-Mach-Zehnder type entangled photon source, or an entangled photon source based on a linear displacement interferometer, or an entangled photon source using interferometers on each entangled photon individually after creation, or a rail-cross entangled photon source, or a single-crystal single-pass entangled photon source with walk-off compensation, or entangled photon sources using group-velocity-matched non-linear crystals, or entangled photon sources with multi-SPDC interference. Beside alignment means forming the particular entangled source structure, for example the Sagnac loop mirrors, each entangled photon source can be adjusted and/or stabilized for example by two mirrors outside the source, and/or a collimator, and/or a lens as alignment means.

In a preferred embodiment, the alignment means for a Sagnac-type source are one or more mirrors, and/or one or more deformable mirrors in front of the source in order to adjust and/or stabilize the spatial mode of the pump beam on an input port of the source, and/or the alignment means for a Sagnac-type source are one or more lenses in front of the source in order to adjust and/or stabilize the beam form and/or the beam size in the non-linear element, and/or the alignment means for a Sagnac-type source are one or more mirrors in the Sagnac loop in order to adjust and/or stabilize the spatial mode of the pump beam through the non-linear element.

In a preferred embodiment, the alignment means for a crossed crystal-type source or BBO-type source are one or more mirrors, and/or one or more deformable mirrors in front of the source in order to adjust and/or stabilize the spatial mode of the pump beam on an input port of the source and in order to adjust and/or stabilize the spatial mode of the pump beam through the non-linear element, and/or the alignment means for a crossed crystal-type source or BBO-type source are one or more lenses in front of the source in order to adjust and/or stabilize the beam form and/or the beam size in the non-linear element.

In a preferred embodiment, the alignment means for an entangled photon source with one non-linear element pumped in two directions are one or more mirrors, and/or one or more deformable mirrors in front of the source in order to adjust and/or stabilize the spatial mode of the pump beam on an input port of the source and in order to adjust and/or stabilize the spatial mode of the pump beam through the non-linear element in a first direction, and/or the alignment means for an entangled photon source with one non-linear element pumped in two directions are one or more mirrors or deformable mirrors in the source in order to adjust and/or stabilize the spatial mode of the pump beam through the non-linear element in a second direction, and/or the alignment means for an entangled photon source with one non-linear element pumped in two directions are one or more lenses in front of the source in order to adjust and/or stabilize the beam form and/or the beam size in the non-linear element.

In a preferred embodiment, the non-linear element is a birefringent element, preferably one or more birefringent crystal, more preferably a periodically poled birefringent crystal.

In a preferred embodiment, the transmission of the laser beam can be realized via a free-space channel and/or a fiber channel.

The above and other aspects, features and advantages of the present invention will become more apparent from the following detailed description when taken in conjunction with the accompanying drawings.

### BRIEF DESCRIPTION OF THE DRAWINGS:

FIG. 1: schematic diagram of a first embodiment of the inventive system with a single mode fiber as spatial mode filter means arranged behind the source;

FIG. 2: schematic diagram of the embodiment of FIG. 1 with an aperture as spatial mode filter means arranged behind the source;

FIG. 3: schematic diagram of a second embodiment of the inventive system with a spatial mode filter means as a single mode fiber between the source and the pump laser in the beam path of the pump beam;

FIG. 4: schematic diagram of the embodiment of FIG. 3 with a spatial mode filter means as a single mode fiber arranged branching off from the pump beam between the source and the pump laser;

FIG. 5: schematic diagram of the embodiment of FIG. 1 with two mirrors and a lens as alignment means in front of the source;

FIG. 6: schematic diagram of the embodiment of FIG. 4 with two mirrors in the source as alignment means;

FIG. 7: schematic diagram of the embodiment of FIG. 4 with one mirror in the source as alignment means.

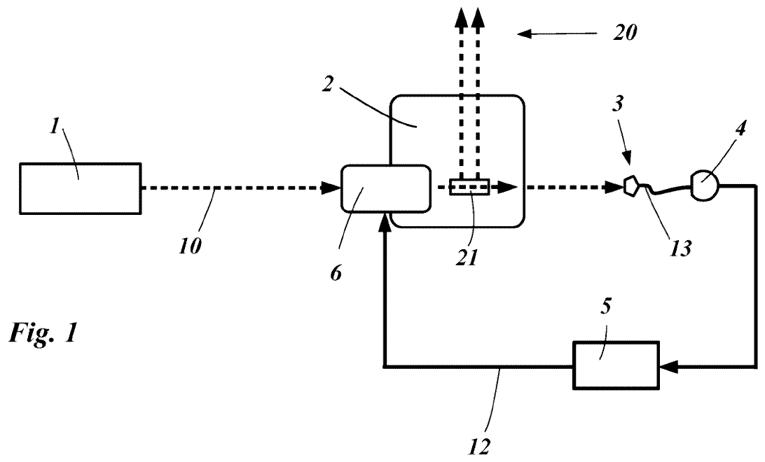

FIG. 1 shows a first embodiment of the inventive system for alignment and/or stabilization comprising a pump laser 1, a source 2 and one or more alignment means 6.

In the pump laser 1 a pump beam 10 is generated and guided to the source 2. In the source 2 a non-linear element 21 for the generation of entangled photons 20 is arranged. The entangled photons 20 are generated by pumping the non-linear element with the pump beam 10. The spatial mode of the pump beam 10 through the non-linear element 21 is crucial, since the pump beam 10 inherits its spatial mode to the entangled photons 20.

The guidance of the pump beam 10 in the source and the arrangement of the nonlinear element 21 in the source is formed in order to generate entangled photons. This can be for example realized in a Sagnac-source configuration, or a two-direction pumped crystal configuration, or a crossed crystal configuration, or a BBO configuration.

By the schematic presentation in FIG. 1 is shown, that one or more alignment means 6 can be arranged in the system, whereby each alignment means 6 can be arranged in front of the source 2 or in the source 2. The alignment means 6 guide or form the spatial mode of the pump beam 10 to the non-linear element 21 to generate entangled photons 20.

The inventive system comprises further a spatial mode filter means 3 arranged in the embodiment of FIG. 1 behind the source and formed in the embodiment of FIG. 1 by a single mode fiber 13. Behind the source 2 means here, that the pump beam is first used for the generation of the entangled photons, and after that guided out of the source 2 towards the spatial mode filter means 3.

The pump beam 10 is spatially mode filtered by the spatial mode filter means 3 and then detected by a detection means 4. Thus, a detection signal by the detection means 4 is proportional to the coupling of the spatial mode of the pump beam 10 into the single mode fiber 13. The detection means 4 can be coupled to the single mode fiber 13 as shown in FIG. 1 or the spatially filtered pump beam 11 (not shown in FIG. 1) is detected by the detection means 4 behind the single mode fiber 13.

The inventive system of FIG. 1 also comprises a control means 5, which receives a detection signal of the detection means 4. In the control means 5 a control signal is generated and sent to the one or more alignment means 6 in order to align and/or stabilize the spatial mode of the pump beam 10, and thus align and/or stabilize the source 2 for the generation of entangled photons 20. A control loop is formed by the pump laser 1, the one or more alignment means 6 as actuation means, the spatial mode filter means 3, the detection means 4 and the control means 5.

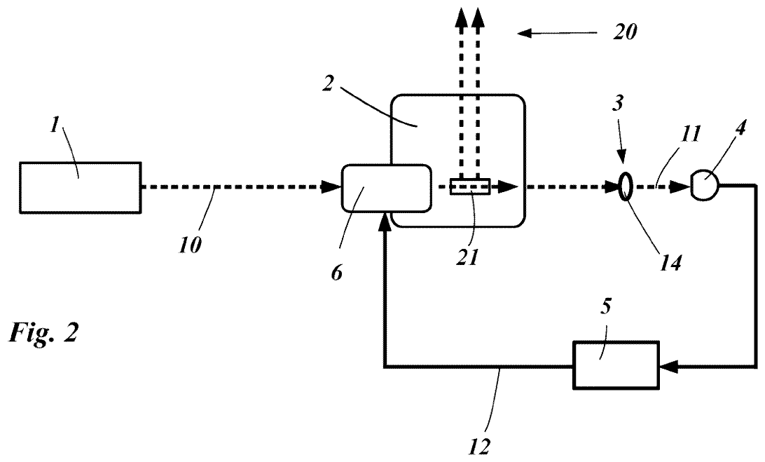

FIG. 2 shows another embodiment of the inventive system of FIG. 1, whereby FIG. 2 differs from FIG. 1 only in that the spatial mode filter means 3 is formed as an aperture 14, whereby a spatially filtered pump beam 11 is detected by the detection means 4.

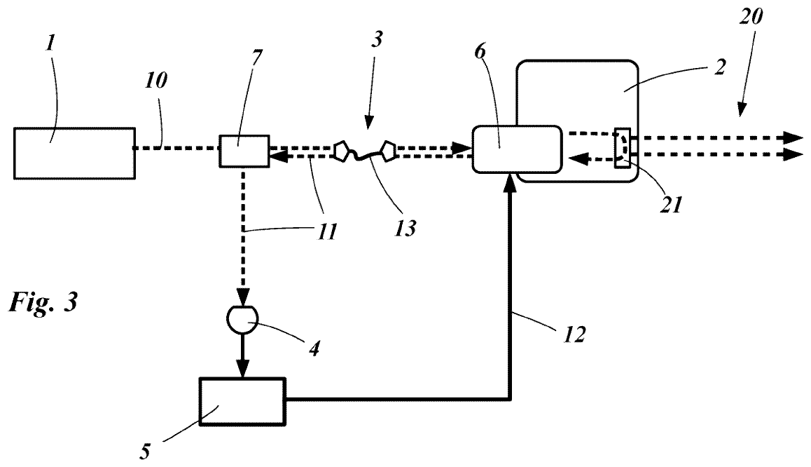

FIG. 3 shows a second embodiment of the inventive system for alignment and/or stabilization comprising the pump laser 1, the source 2 and one or more alignment means 6 arranged in front and/or in the source 2.

In the embodiment of FIG. 3 the spatial mode filter means 3 is arranged between the pump laser 1 and the source 2. For that, the pump beam 10 is reflected or guided back inside of the source 2 towards the pump laser 1. This means the pump beam 10 enters and leaves the source 2 on the same spatial mode beam path or the substantially same spatial mode beam path. The pump beam 10 is then guided to the spatial mode filter means 3 formed in the embodiment of FIG. 3 by a single mode fiber 13, spatially filtered and then reflected on a beam splitter 7 in order to detect the spatially filtered pump beam 11 in the detection means 4. Instead of a beam splitter 7 also an isolator can be used.

In the embodiment of FIG. 3 the spatially filtered pump beam 11 as well as the pump beam 10 is transmitted through the single mode fiber 13. In this embodiment, the single mode fiber 13 is used as a cleaning device for the pump beam 10 before the entangled photon generation and in addition as a spatial mode filter for the pump beam 10 after the entangled photon generation.

As the inventive system of FIG. 1 the inventive system of FIG. 3 also comprises a control means 5, which receives the detection signal of the detection means 4. In the control means 5 the control signal is generated and sent to the one or more alignment means 6 in order to align and/or stabilize the spatial mode of the pump beam 10, and thus align and/or stabilize the source 2 for the generation of entangled photons 20. A control loop is formed by the pump laser 1, the one or more alignment means 6 as actuation means, the spatial mode filter means 3, the detection means 4 and the control means 5.

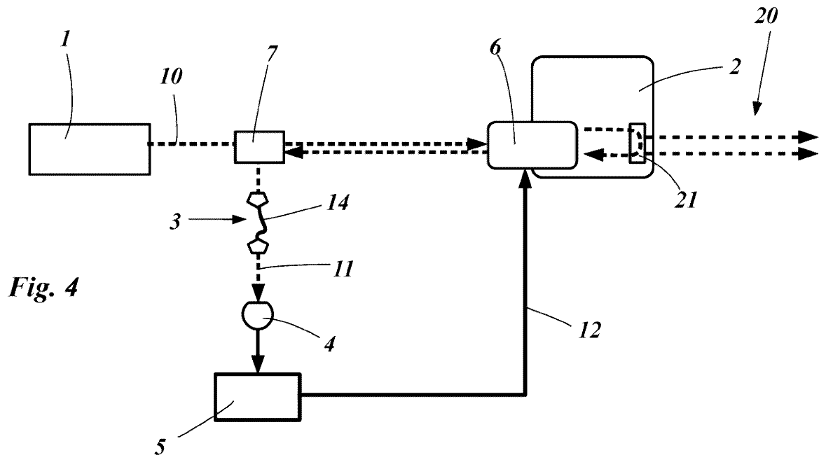

FIG. 4 shows another embodiment of the inventive system of FIG. 3, whereby FIG. 4 differs from FIG. 3 only in that the spatial mode filter means 3 is arranged behind the beam splitter 7 output in order to branch off from the pump beam 10 between the source 2 and the pump laser 1. Instead of a beam splitter 7 also an isolator can be used.

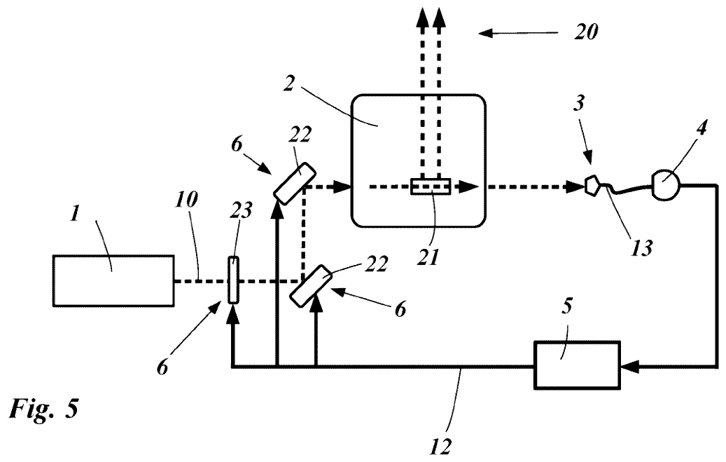

FIG. 5 shows another embodiment of the inventive system of FIG. 1, whereby FIG. 5 differs from FIG. 1 only in that as an example multiple alignment means 6 are arranged in front of the source 2. In this embodiment, the alignment means 6 are two mirrors 22 in order to align and/or adjust the spatial mode of the pump beam 10 by guidance to the source 2. An additional alignment means 6 is arranged between the pump laser 1 and the source 2 formed as a lens 23 in order to align and/or adjust the spatial mode of the pump beam 10 by beam shaping and/or focusing of the pump beam 10 in the non-linear element 21.

In the embodiment of FIG. 5, the tip-tilt-adjustment and/or the position of the mirrors 22 and the position and/or the focal length and/or the focal form of the lens 23 are controlled for the alignment and/or stabilization of the spatial mode of the pump beam 10.

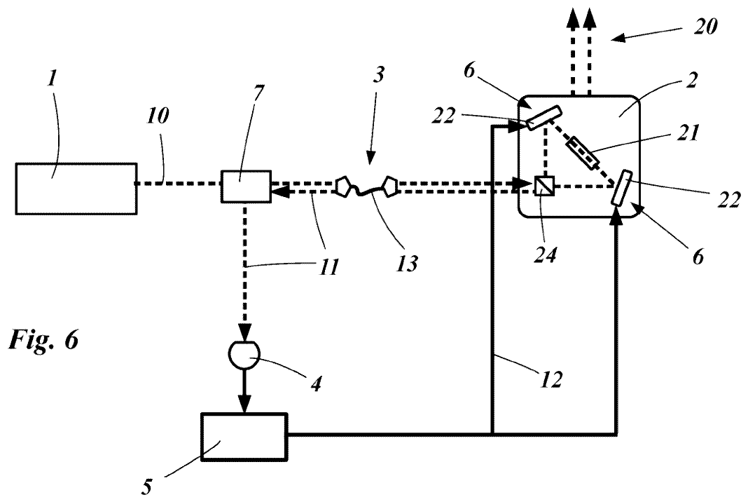

FIG. 6 shows another embodiment of the inventive system of FIG. 3, whereby FIG. 6 differs from FIG. 3 only in that as an example multiple alignment means 6 are arranged in the source 2. In this embodiment, the alignment means 6 are two mirrors 22 forming a Sagnac-loop with a polarizing beam splitter 24 and the non-linear element 21 for a Sagnac type source. In the embodiment of FIG. 6, the tip-tilt-adjustment and/or the position of the mirrors 22 are controlled for the alignment and/or stabilization of the spatial mode of the pump beam 10. The output of the entangled photons 20 in FIG. 6 is only schematically depicted.

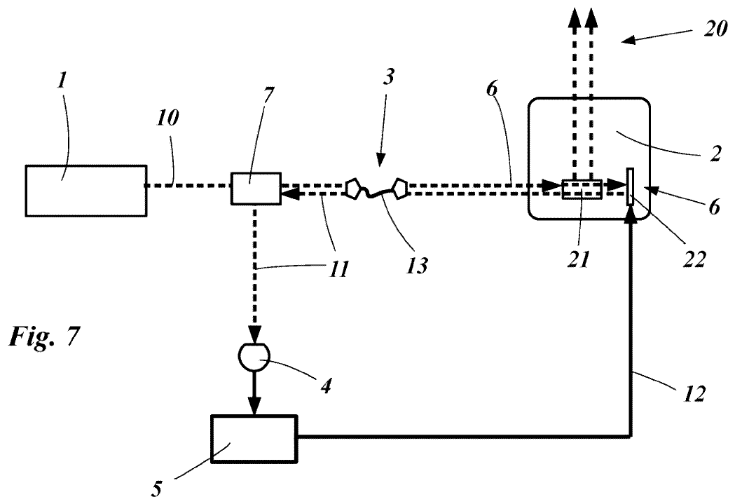

FIG. 7 shows another embodiment of the inventive system of FIG. 3, whereby FIG. 7 differs from FIG. 3 only in that as an example one alignment means 6 is arranged in the source 2. In this embodiment, the alignment means 6 is the mirror 22 behind the non-linear element 21, forming together with the non-linear element 21 a two-direction pumped crystal source 2. In the embodiment of FIG. 7, the tip-tilt-adjustment and/or the position of the mirror 22 is controlled for the alignment and/or stabilization of the spatial mode of the pump beam 10 in the second transmission direction.

It is clear, that the different spatial mode filter means 3 from FIG. 2 also can be used in the embodiment of FIG. 5. Also, it is clear, that the embodiments of the alignment means 6 of the FIGS. 5, 6 and 7 can be combined in any way.

### REFERENCE SIGNS

1 pump laser
2 source
3 spatial mode filter means
4 detection means
5 control means
6 alignment means
7 beam splitter
10 pump beam
11 spatial filtered pump beam
12 control signal
13 single mode fiber
14 aperture
20 entangled photons
21 non-linear element
22 mirror
23 lens
24 polarizing beam splitter

1. A method for alignment and stabilization of an entangled photon source, comprising:
i) generation of a polarized pump beam by a pump laser;
ii) generation of entangled photons by guidance of the pump beam to a non-linear element in the source via one or more alignment means;
iii) measurement of the pump beam after the generation of the entangled photons by spatial mode filtering of the pump beam by a spatial mode filter means and detection of the spatial mode filtered pump beam by a detection means after the generation of the entangled photons;
iv) generation of a control signal based on the spatial mode filtered pump beam in a control means; and
v) adjustment of the one or more alignment means by the control signal in order to align and/or stabilize the spatial mode of the pump beam in the source.

2. The method according to claim 1,
wherein the control signal is an electrical signal whose magnitude is proportional to the spatial mode filtered and detected pump beam, and
proportional to an intensity of the spatial mode filtered and detected pump beam.

3. The method according to claim 1,
wherein steps i) to v) form a control during the generation of the entangled photons by pumping the non-linear element by the pump beam.

4. The method according to claim 1,
wherein the control comprises:
a) the generation of the pump beam in step i),
b) the measurement of the pump beam in step iii) after the generation of the entangled photons in step ii),
c) the generation of the control signal based on the spatial mode filtered and detected pump beam in step iv), and
d) the adjustment of the one or more alignment means by the control signal in step v).

5. The method according to claim 1,
wherein the control means in step iv) compares an actual value of the spatial mode filtered pump beam with a setpoint value, and wherein the control means determines and generates the control signal on the basis of the comparison of the actual value of the spatial mode filtered pump beam with the setpoint value.

6. The method according to claim 1,
wherein the spatial mode filtering in step iii) is realized by coupling the pump beam into a single mode fiber or by one or more apertures.

7. The method according to claim 1,
wherein a detected signal of the spatial mode filtered and detected pump beam is proportional to an intensity of a spatial mode overlap.

8. The method according to claim 1,
wherein the pump beam is spatially mode filtered in the spatial mode filter means after a transmission of the pump beam through the source.

9. The method according to claim 1,
wherein the pump beam is spatially mode filtered in the spatial mode filter means after a reflection of the pump beam in the source or a guidance back of the pump beam in the source towards the pump laser.

10. The method according to claim 1,
wherein the control signal of the spatial mode filtered pump beam is used for the alignment and/or stabilization of the spatial mode of the pump beam.

11. The method according to claim 1,
wherein at least one of a position and tip-tilt alignment of one or more mirrors, and/or the a position and tip-tilt alignment and deformation of one or more deformable mirrors, and a position of one or more apertures, and a position of one or more lenses, and one or more waveplates, and one or more birefringent elements is controlled in order to align and stabilize the spatial mode of the pump beam.

12. The method according to claim 1,
wherein a physical variable to be controlled and on which the control means act for the mirror as the alignment means is a position of the mirror or the an angle of reflection of the mirror, and
wherein a physical variable to be controlled and on which the control means act for the alignment means as a deformable mirror is a position of the deformable mirror or an angle of reflection of the deformable mirror, or the deformation of the surface of the deformable mirror, and
wherein a physical variable to be controlled and on which the control means act for the alignment means as an aperture is the position of the aperture, or the diameter of the aperture, or the form of the aperture, and
wherein a physical variable to be controlled and on which the control means act for the alignment means as a lens is a position of the lens, or the an angle of transmission of the pump beam through the lens, or a focal length of the lens, and
wherein a physical variable to be controlled and on which the control means act for the alignment means as a collimator is a position of the collimator, or the angle of transmission of the pump beam through the collimator, or a focal length of the collimator, and
wherein a physical variable to be controlled and on which the control means act for the alignment means as a beam displacer is a position of the beam displacer.

13. A system for alignment and stabilization of an entangled photon source, comprising:
a pump laser generating a pump beam;
a source;
one or more alignment means;
whereby the source is arranged behind the pump laser and comprises a non-linear element for the generation of entangled photons, and
whereby the alignment means are arranged inside or outside of the source in order to guide the pump beam to the non-linear element after the generation of the entangled photons;
spatial mode filter means arranged behind an output port of the source of the pump beam;
detection means, arranged behind the spatial mode filter means; and
control means for controlling the spatial mode of the pump beam, whereby a control loop is formed by the pump laser, the one or more alignment means as actuation means, the spatial mode filter means, the detection means and the control means.

14. The system according to claim 13,
wherein the alignment means is a movable mirror, a deformable mirror, an aperture, a lens, a collimator, or a beam displacer.

15. The system according to claim 13,
wherein the spatial mode filter means is a single mode fiber or one or more apertures.
